(19) United States
(12) Patent Application Publication
(10) Pub. No.: US 2026/0106682 A1
(43) Pub. Date: Apr. 16, 2026

(54) VEHICLE RADIO APPARATUS AND CONTROL METHOD THEREOF

(71) Applicants: HYUNDAI MOTOR COMPANY, Seoul (KR); KIA CORPORATION, Seoul (KR)

(72) Inventors: Jae Kyu Yu, Hwaseong-si (KR); Oh Yun Kwon, Hwaseong-si (KR); Ji Hun Lim, Hwaseong-si (KR)

(73) Assignees: HYUNDAI MOTOR COMPANY, Seoul (KR); KIA CORPORATION, Seoul (KR)

(21) Appl. No.: 19/171,016

(22) Filed: Apr. 4, 2025

(30) Foreign Application Priority Data
Oct. 10, 2024 (KR) 10-2024-0137546

(51) Int. Cl. H04H 40/36

(52) U.S. Cl. CPC H04H 40/36

(57) ABSTRACT

A control method of a vehicle radio apparatus includes: confirming a broadcast name of an Internet radio being listened to; searching a frequency at which a first analog radio having the broadcast name is being transmitted; determining whether a signal quality of the first analog radio received at the frequency is good; determining whether the Internet radio and the first analog radio are the same broadcast when it is determined that the signal quality of the first analog radio is not good; and converting the Internet radio into a second analog radio and transmitting the second analog radio when it is determined that the Internet radio and the first analog radio are the same broadcast.

### CROSS REFERENCE TO RELATED APPLICATION

This application claims priority from Korean Patent Application No. 10-2024-0137546, filed on Oct. 10, 2024, which is hereby incorporated by reference for all purposes as if fully set forth herein.

### TECHNICAL FIELD

The present disclosure relates to a vehicle radio apparatus and a control method thereof.

### BACKGROUND

The statements in this section merely provide background information related to the present disclosure and do not necessarily constitute prior art.

A vehicle may be equipped with a radio, digital multimedia broadcasting (DMB), and the like, and a passenger in the vehicle may use these to listen to radio (AM/FM) or DMB radio broadcasts.

There are three types of radio: i) an analog radio such as amplitude modulation (AM) and a frequency modulation (FM); ii) a digital radio such as digital audio broadcasting (DAB) and a digital radio Mondale (DRM); and iii) an Internet radio transmitted via Internet protocol.

Analog radio has a problem in that a reception signal weakens and a broadcast quality deteriorates as a vehicle moves away from a transmitter of the broadcast being listened to. For example, in places such as underpasses, underground parking lots, and tunnels, a reception rate is low because radio waves have difficulty reaching the antenna attached to the vehicle.

Internet radio is similar to analog radio in that it is difficult for radio waves to reach vehicles or in-vehicle terminals, but because facilities such as base stations and a repeater are installed more densely than radio, a reception rate is generally higher than that of analog radio.

Telematics technology, which combines automobiles and wireless communication technology, is attracting attention. The telematics technology is applied to various functions such as navigation functions, information search functions, in-vehicle environment setting functions, and autonomous driving functions, allowing vehicle drivers and passengers to travel comfortably.

In a connected car that can access wireless communication, such as a vehicle that can listen to Internet radio, radio broadcasts can be listened to via Internet radio independently of the reception status of the analog radio. Therefore, in the vehicle that can listen to Internet radio, even when the reception status of the analog radio is poor, desired broadcasts can be easily listened to via Internet radio.

Therefore, there is a need for a technology for enabling a vehicle that can only listen to analog radio, for example, a vehicle that cannot listen to Internet radio, to easily listen to radio broadcasts even when the reception status of analog radio transmitted by a radio station is not good.

### SUMMARY

An object of the present disclosure is to provide a vehicle radio apparatus and a control method thereof, which enables a vehicle that cannot listen to Internet radio to easily listen to radio broadcasts even when the reception status of an analog radio transmitted by a radio station is not good. Specifically, a main object of the present disclosure is to provide a vehicle radio apparatus and a control method thereof enabling the vehicle that cannot listen to Internet radio to easily listen to radio broadcasts by, when a vehicle that can listen to Internet radio is adjacent to the vehicle that cannot listen to Internet radio, modulating the Internet radio that the vehicle that can listen to Internet radio is listening to into an analog radio and transmitting the analog radio to the vehicle that cannot listen to Internet radio so that the vehicle that cannot listen to Internet radio receives the analog radio transmitted from the vehicle that can listen to Internet radio.

The technical objects of the present disclosure are not limited to those described above, and other technical objects not mentioned above may be understood clearly by those having ordinary skill in the art from the descriptions given below.

An embodiment of the present disclosure provides a control method of a vehicle radio apparatus, the control method including: confirming a broadcast name of an Internet radio being listened to; searching a frequency at which a first analog radio having the broadcast name is being transmitted; determining whether a signal quality of the first analog radio received at the frequency is good; determining whether the Internet radio and the first analog radio are the same broadcast when it is determined that the signal quality of the first analog radio is not good; and converting the Internet radio into a second analog radio and transmitting the second analog radio when it is determined that the Internet radio and the first analog radio are the same broadcast.

An embodiment of the present disclosure provides a vehicle radio apparatus, including: an Internet radio receiving and processing device; an analog radio receiving and processing device; a radio control device; and an analog radio transmitting and processing device, wherein the radio control device: confirms a broadcast name of an Internet radio being listened to, using the Internet radio receiving and processing device; searches a frequency at which a first analog radio having the broadcast name is being transmitted, using the analog radio receiving and processing device; determines whether a signal quality of the first analog radio received at the frequency is good; determines whether the Internet radio and the first analog radio are the same broadcast when it is determined that the signal quality of the first analog radio is not good; and converts the Internet radio into a second analog radio and transmits the second analog radio, using the analog radio transmitting and processing device when it is determined that the Internet radio and the first analog radio are the same broadcast.

An embodiment of the present disclosure provides a vehicle radio apparatus including an analog radio receiving and processing device that receives a second analog radio transmitted by a surrounding vehicle, wherein the second analog radio is a signal generated by the surrounding vehicle based on confirming a broadcast name of an Internet radio being listened to, searching a frequency at which a first analog radio having the broadcast name is being transmitted, determining whether a signal quality of the first analog radio received at the frequency is good, determining whether the Internet radio and the first analog radio are the same broadcast when it is determined that the signal quality of the first analog radio is not good, and converting the Internet radio into the second analog radio when it is determined that the Internet radio and the first analog radio are the same broadcast.

According to one embodiment of the present disclosure, even when the vehicle that cannot listen to Internet radio has a poor reception status of the analog radio transmitted by the radio station, the vehicle can listen to radio broadcasts stably even in places with unstable signal reception environments, such as underpasses, by receiving analog radio transmitted from an adjacent vehicle that can listen to Internet radio.

According to one embodiment of the present disclosure, a vehicle that can listen to the Internet radio determines whether an analog radio transmitted by a radio station and the Internet radio are the same broadcast, and transmits an analog radio to the vehicle that cannot listen to the Internet radio only when the analog radio and the Internet radio are the same broadcast, thereby preventing a listener from listening to an unwanted broadcast due to a discrepancy in the broadcast content between the analog radio and the Internet radio.

According to one embodiment of the present disclosure, the radio control device calculates the similarity in advance before the vehicle enters an underpass or the like, and even in a case where the analog radio and Internet radio are determined to be different broadcasts based on the similarity of a current cycle, when the analog radio and the Internet radio are determined to be the same broadcast based on the similarity of a past cycle, the radio control device determines the analog radio and Internet radio to be the same broadcast, thereby preventing errors due to signal quality degradation and making it possible to determine more accurately whether the broadcasts are the same.

The technical effects of the present disclosure are not limited to the technical effects described above, and other technical effects not mentioned herein may be understood to those having ordinary skill in the art to which the present disclosure belongs from the description below.

### BRIEF DESCRIPTION OF THE DRAWINGS

FIG. 1 is a diagram illustrating an example in which a vehicle that can listen to an Internet radio transmits analog radio to a vehicle that cannot listen to the Internet radio according to one embodiment of the present disclosure.

FIG. 2 is a diagram illustrating a configuration and operation of a vehicle radio apparatus mounted on the vehicle that can listen to the Internet radio according to one embodiment of the present disclosure.

FIG. 3 is a diagram illustrating a detailed configuration of the vehicle radio apparatus mounted on the vehicle that can listen to Internet radio according to one embodiment of the present disclosure.

FIG. 4 is a schematic diagram illustrating a structure of a vehicle radio apparatus mounted on a vehicle that cannot listen to the Internet radio according to one embodiment of the present disclosure.

FIG. 5 is a flowchart schematically illustrating a control method of the vehicle radio apparatus mounted on the vehicle that can listen to the Internet radio according to one embodiment of the present disclosure.

FIG. 6 is a diagram illustrating a process in which the radio control device according to one embodiment of the present disclosure determines whether the Internet radio and the first analog radio are the same broadcast in two steps.

FIG. 7 is a block diagram schematically illustrating an example computing device according to one embodiment of the present disclosure that can be used to implement apparatuses and methods described in the present disclosure.

### DETAILED DESCRIPTION

Hereinafter, some embodiments of the present disclosure are described in detail with reference to the accompanying drawings. In the following description, like reference numerals designate like elements, although the elements are shown in different drawings. Further, in the following description of some embodiments, a detailed description of known functions and configurations incorporated therein are omitted for the purpose of clarity and for brevity.

Additionally, various terms such as first, second, A, B, (a), (b), and the like, are used solely to differentiate one component from the other but not to imply or suggest the substances, order, or sequence of the components. Throughout this specification, when a part ‘includes’or ‘comprises’a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

When a component, device, element, or the like of the present disclosure is described as having a purpose or performing an operation, function, or the like, the component, device, or element should be considered herein as being “configured to” meet that purpose or to perform that operation or function.

The following detailed description, together with the accompanying drawings, is intended to describe embodiments of the present disclosure, and is not intended to represent the only embodiments in which the present disclosure may be practiced.

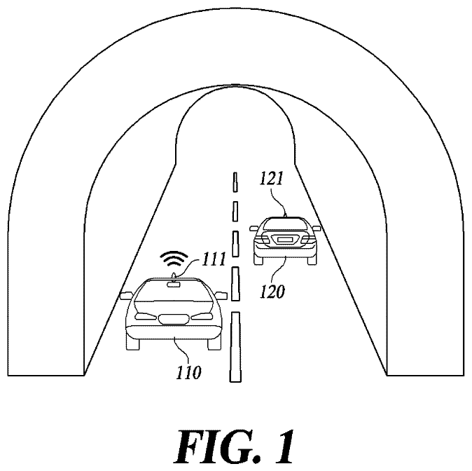

FIG. 1 is a diagram illustrating an example in which a vehicle that can listen to an Internet radio transmits analog radio to a vehicle that cannot listen to the Internet radio according to one embodiment of the present disclosure.

Referring to FIG. 1, a vehicle 110 (i.e., first vehicle 110) that can listen to an Internet radio can transmit analog radio to a vehicle 120 (i.e., second vehicle 120) that cannot listen to the Internet radio, and the vehicle 120 that cannot listen to Internet radio can listen to the analog radio transmitted from the vehicle 110 that can listen to Internet radio. The two vehicles 110 and 120 may be adjacent to each other. The analog radio may be a signal converted from Internet radio being listened to by the vehicle 110.

Transmission and reception of analog radio can be accomplished by antennas 111 and 121 equipped in each vehicle. The antennas 111 and 121 may be rod-shaped antennas, glass antennas, or shark fin antennas. The antennas 111 and 121 may be included in a radio receiver or transmitter. In other words, the antennas 111 and 121 can be included in an analog radio receiving and processing device 20 or an analog radio transmitting and processing device 26.

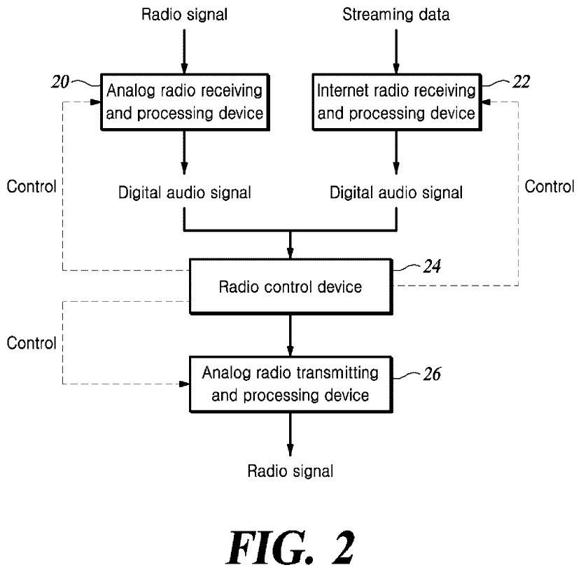

FIG. 2 is a diagram illustrating a configuration and operation of a vehicle radio apparatus mounted on the vehicle that can listen to the Internet radio according to one embodiment of the present disclosure.

Referring to FIG. 2, a vehicle radio apparatus mounted on a vehicle 110 that can listen to Internet radio may include the analog radio receiving and processing device 20, an Internet radio receiving and processing device 22, a radio control device 24, and the analog radio transmitting and processing device 26.

The analog radio receiving and processing device 20 may receive a radio broadcast signal transmitted by a radio broadcast station and convert the received radio broadcast signal into a digital audio signal. The radio broadcast signal may be in the form of radio waves. The radio broadcast signal may be transmitted using a transmission tower located on the ground.

The Internet radio receiving and processing device 22 may receive radio broadcast data transmitted by the radio broadcast station and convert the received radio broadcast data into a digital audio signal. The radio broadcast data may be in the form of streaming data. The radio broadcast data may be transmitted using a server and the Internet.

The radio control device 24 may confirm a broadcast name of the Internet radio being listened to by using the Internet radio receiving and processing device 22. In other words, the radio control device 24 may confirm the broadcast name of the Internet radio being listened to by the vehicle 110 that can listen to the Internet radio based on the signal received by the Internet radio receiving and processing device 22.

The radio control device 24 may search for a frequency at which an analog radio having the same broadcast name as the broadcast name of the Internet radio being listened to is being transmitted, using the analog radio receiving and processing device 20. The radio control device 24 may search for a frequency band of the analog radio having the same broadcast name as the broadcast name of the Internet radio, based on the signal received by the analog radio receiving and processing device 20. The analog radio having the same broadcast name as the broadcast name of the Internet radio may be referred to as a first analog radio for convenience hereinafter.

The radio control device 24 may determine whether the signal quality of the first analog radio is good at the searched frequency. Whether the signal quality is good may be determined using electric field strength. dBμV(decibel-microvolts) may be used as a unit of the electric field strength. For example, the radio control device 24 may determine that the signal quality is not good when the measured electric field strength is less than a threshold value based on the electric field strength of the first analog radio measured at the frequency at which the first analog radio is being transmitted. The threshold value can be 20 dBμV.

When the signal quality of the first analog radio is determined to be not good, the radio control device 24 may determine whether the Internet radio and the first analog radio are the same broadcast. Whether the Internet radio and the first analog radio are the same broadcast may be determined using similarity. The similarity may be calculated based on a correlation coefficient between the Internet radio and the first analog radio. The radio control device 24 can calculate a correlation coefficient between the Internet radio and the first analog radio and calculate the similarity based on the correlation coefficient. When the similarity is equal to or greater than a threshold value, the Internet radio and the first analog radio may be determined to be the same broadcast. The correlation coefficient may have a value between 0 and 1. The closer the correlation coefficient is to 1, i.e., the higher the similarity, the higher the probability that they are determined to be the same broadcast. The similarity can be a dual tuner acoustic correlation (DTAC) value.

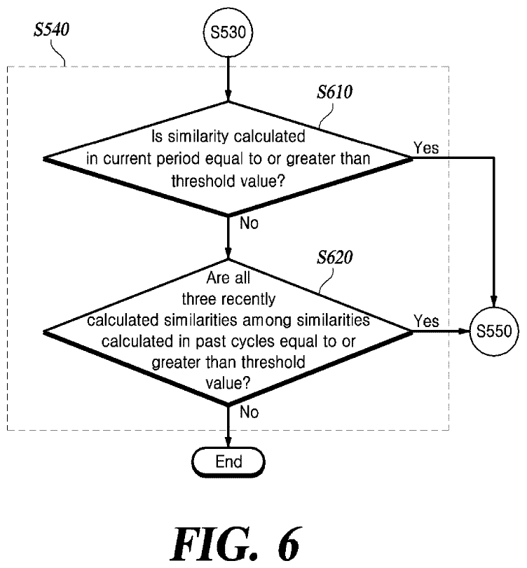

Optionally, the radio control device 24 may determine whether the Internet radio and the first analog radio are the same broadcast in two steps. The first step may be based on a similarity calculated in a current cycle. The second step may be based on a similarity calculated in a past cycle. When a vehicle enters an underpass, an underground parking lot, a tunnel, or the like, the signal quality of the first analog radio may deteriorate. As a result, the similarity between the Internet radio and the first analog radio may be calculated to be lower than the actual value, and may be mistakenly determined as a different broadcast even though they are the same broadcast. In other words, when the signal quality of the first analog radio is determined to be not good, the similarity may be distorted differently from the actual value because the vehicle has already entered a place with a weak signal, such as an underpass. To solve this problem, the radio control device 24 of the present disclosure may calculate the similarity between the Internet radio and the first analog radio in advance based on a certain time cycle before the vehicle enters an underpass, or the like. The process of determining whether Internet radio and the first analog radio are the same broadcast in two steps is described in detail below with reference to FIG. 6.

When the Internet radio and the first analog radio are determined to be the same broadcast, the radio control device 24 can convert the Internet radio into a second analog radio and transmit the converted second analog radio using the analog radio transmitting and processing device 26. The second analog radio may be conveniently referred to as a second analog radio hereinafter in order to distinguish the second analog radio from the first analog radio received by the analog radio receiving and processing device 20. The second analog radio may be a signal converted from Internet radio bieing listened to by the Internet radio receiving and processing device 22, where the conversion is performed by the Internet radio receiving and processing device 22 and the analog radio transmitting and processing device 26. Since the Internet radio and the first analog radio are determined to be the same broadcast, the broadcast contents of the second analog radio and the first analog radio may be the same, except for the different generating entities. The radio control device 24 may receive the digital audio signal from the Internet radio receiving and processing device 22 and transmit the digital audio signal to the analog radio transmitting and processing device 26.

The analog radio transmitting and processing device 26 may convert the digital audio signal into radio wave forms based on the digital audio signal received from the radio control device 24 to generate a second analog radio. The analog radio transmitting and processing device 26 can transmit the generated second analog radio in the radio wave form. The transmitted second analog radio may be received by a surrounding vehicle. In other words, the vehicle radio apparatus mounted on a vehicle 110 that can listen to Internet radio may transmit the second analog radio to the vehicle 120 that cannot listen to Internet radio.

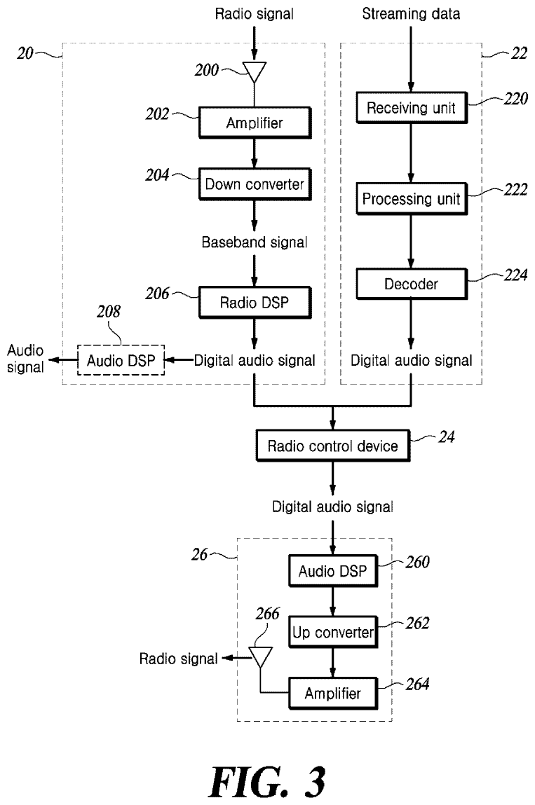

FIG. 3 is a diagram illustrating a detailed configuration of the vehicle radio apparatus mounted on the vehicle that can listen to Internet radio according to one embodiment of the present disclosure. FIG. 3 is basically the same as FIG. 2, but is a drawing illustrating the configuration of the apparatus in more detail compared to FIG. 2.

Referring to FIG. 3, a vehicle radio apparatus mounted on a vehicle 110 that can listen to the Internet radio may include the analog radio receiving and processing device 20, the Internet radio receiving and processing device 22, the radio control device 24, and the analog radio transmitting and processing device 26.

The analog radio receiving and processing device 20 may include an antenna 200, an amplifier 202, a down converter 204, and a radio digital signal processor (DSP) 206. The antenna 200 may receive a radio signal. The antenna 200 may be the same device as the antenna 111. The amplifier 202 may amplify a radio signal received using the antenna 200. As a result of the amplification, a signal-to-noise ratio (SNR) of the radio signal may be improved. The amplifier 202 may be a low noise amplifier (LNA). The down converter 204 may demodulate the radio signal and convert the radio signal into a baseband signal. The down converter 204 may include a tuner. The tuner may receive a frequency at which listening is being performed in the vehicle. In other words, the tuner may receive a signal that matches the frequency of the broadcast at which the listening is being performed. In other words, the tuner may select and receive a frequency of a specific broadcasting station from a frequency band of the broadcasting station. The tuner may include an amplifier (not illustrated), a filter (not illustrated), a mixer (not illustrated), and an oscillator (not illustrated). The amplifier (not illustrated) included in the tuner may be distinguished from the amplifier 202. The amplifier (not illustrated) included in the tuner may be, for example, an intermediate frequency amplifier. The tuner may demodulate a radio signal and convert the demodulated radio signal into a baseband signal. In other words, the tuner may demodulate an electromagnetic wave signal and convert the electromagnetic wave signal into an analog signal. The radio DSP 206 may convert the baseband signal into a digital audio signal. The radio DSP 206 may perform processing such as equalizing, noise reduction, and filtering to improve signal quality.

Optionally, the analog radio receiving and processing device 20 may include an audio DSP 208. The audio DSP 208 may convert the digital audio signal into an audio signal. The audio signal may be an analog signal. The audio signal may be transmitted to the passengers of the vehicle using an output device (not illustrated), for example, a speaker.

The Internet radio receiving and processing device 22 may include a receiving unit 220, a processing unit 222, and a decoder 224. The receiving unit 220 may receive streaming data. The receiving unit 220 may be implemented using a network interface card (NIC, not illustrated) and a router. The receiving unit 220 may be connected to a network and receive data. The network may be the Internet. The data may be radio broadcast data, i.e., streaming data. The streaming data may be received in the form of packets. The processing unit 222 may process the streaming data. The processing unit may be implemented using a memory (not illustrated) and a processor (not illustrated). The processing unit 222 may reassemble the streaming data in the form of packets and process the streaming data into an audio stream. The decoder 224 may convert the audio stream into a digital audio signal. The decoder 224 may be implemented using a digital signal processor (DSP, not illustrated). The process of converting the audio stream into the digital audio signal may include decoding the compressed data.

The radio control device 24 may be implemented using a computing device 70. One or more of the processes performed by the radio control device 24 may be performed by a processor 720 included in the computing device 70. In other words, the processor 720 may confirm the broadcast name of the Internet radio being listened to, search for a frequency at which an analog radio having the same broadcast name as the Internet radio being listened to is being transmitted, determine whether the signal quality of the first analog radio is good at the searched frequency, and determine whether the Internet radio and the first analog radio are the same broadcast.

The analog radio transmitting and processing device 26 may include an audio DSP 260, an up converter 262, an amplifier 264, and an antenna 266. The antenna 266 may be the same device as the antenna 111. Some of the processes performed in the analog radio receiving and processing device 20 may be performed in reverse to become processes performed in the analog radio transmitting and processing device 26. Based on this principle, the vehicle 110 that can listen to Internet radio may use a receiving antenna as a transmitting antenna when necessary. In other words, the antenna 200 and the antenna 266 may be the same antenna 111. The audio DSP 260 may convert the digital audio signal into a baseband signal. The audio DSP 260 may include a digital-to-analog converter (DAC). The up converter 262 may modulate a baseband signal and convert the modulated baseband signal into a radio signal. The up converter 262 may include an amplifier (not illustrated), a filter (not illustrated), a mixer (not illustrated), and an oscillator (not illustrated). The amplifier (not illustrated) included in the up converter 262 may be distinguished from the amplifier 264. The amplifier 264 may amplify a radio signal converted using the up converter 262. The amplifier 264 may be a power amplifier (PA). The antenna 266 may transmit the amplified radio signal.

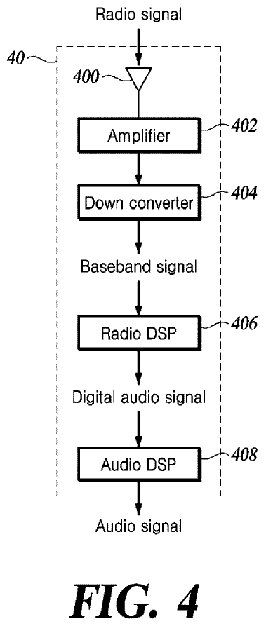

FIG. 4 is a schematic diagram illustrating a structure of a vehicle radio apparatus mounted on a vehicle that cannot listen to the Internet radio according to one embodiment of the present disclosure.

Referring to FIG. 4, a vehicle radio apparatus mounted in a vehicle 120 that cannot listen to Internet radio may include an analog radio receiving and processing device 40.

In general, an analog radio receiving and processing device 40 may receive radio broadcast data transmitted by a radio broadcast station and convert the received radio broadcast signal into an audio signal. The radio broadcast data may be in the form of radio waves. The radio broadcast signal may be transmitted using a transmission tower located on the ground.

In the present disclosure, when a vehicle 120 that cannot listen to internet radio enters an underground passage, an underground parking lot, a tunnel, or the like, the signal quality of the radio broadcast data transmitted from the radio station, i.e., the first analog radio, may deteriorate. In this case, the vehicle radio apparatus mounted on a vehicle 120 that cannot listen to the Internet radio may receive the radio broadcast data transmitted by the vehicle 110 that can listen to the Internet radio, i.e., the second analog radio, and convert the received radio broadcast signal into an audio signal. In other words, the vehicle radio apparatus mounted on a vehicle 120 that cannot listen to the Internet radio may receive the second analog radio having good signal quality instead of the first analog radio having poor signal quality.

The analog radio receiving and processing device 40 may include an antenna 400, an amplifier 402, a down converter 404, a radio DSP 406, and an audio DSP 408. The antenna 400 may be the same device as the antenna 121. Since the analog radio receiving and processing device 40 is basically the same device as the analog radio receiving and processing device 20, detailed descriptions of the antenna 400, the amplifier 402, the down converter 404, the radio DSP 406, and the audio DSP 408 are omitted because the descriptions overlap with those of the antenna 200, the amplifier 202, the down converter 204, the radio DSP 206, and the audio DSP 208.

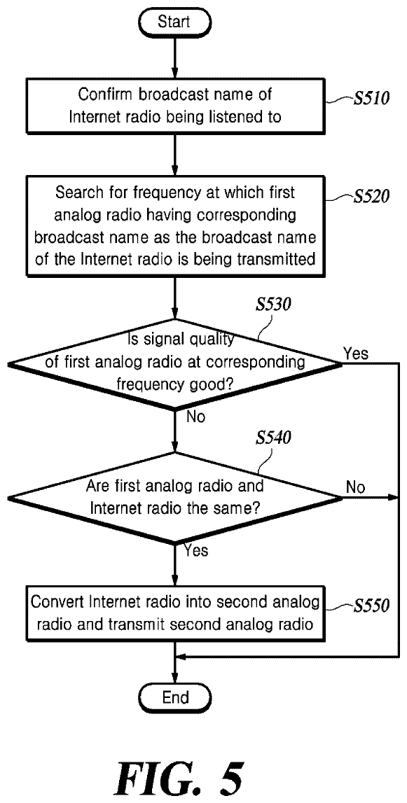

FIG. 5 is a flowchart schematically illustrating a control method of the vehicle radio apparatus mounted on the vehicle that can listen to the Internet radio according to one embodiment of the present disclosure.

Referring to FIG. 5, the radio control device 24 may confirm the broadcast name of the Internet radio being listened to by using the Internet radio receiving and processing device 22 (S510). The radio control device 24 may change the settings of the Internet radio receiving and processing device 22. The process in which the radio control device 24 changes the settings of the Internet radio receiving and processing device 22 may be called a process in which the radio control device 24 controls the Internet radio receiving and processing device 22.

The radio control device 24 may search for a frequency at which the first analog radio having the same broadcast name as the broadcast name of the Internet radio is being transmitted by using the analog radio receiving and processing device 20 (S520). The radio control device 24 may change the settings of the analog radio receiving and processing device 20. The process of changing the settings of the analog radio receiving and processing device 20 by the radio control device 24 may be called a process in which the radio control device 24 controls the analog radio receiving and processing device 20.

The radio control device 24 may determine whether the signal quality of the first analog radio received at the frequency at which the first analog radio having the same broadcast name as the broadcast name of the Internet radio is being transmitted is good (S530).

When the signal quality of the first analog radio is determined to be not good, the radio control device 24 may determine whether the first analog radio and the Internet radio are the same broadcast (S540). Optionally, the radio control device 24 may determine whether the first analog radio and the Internet radio are the same broadcast in two steps. This is described in detail below with reference to FIG. 6.

When it is determined that the first analog radio and the Internet radio are the same broadcast, the radio control device 24 may convert the Internet radio into the second analog radio and transmit the converted second analog radio using the analog radio transmitting and processing device 26 (S550). The radio control device 24 can change the settings of the analog radio transmitting and processing device 26. The process in which the radio control device 24 changes the settings of the analog radio transmitting and processing device 26 can be called a process in which the radio control device 24 controls the analog radio transmitting and processing device 26.

FIG. 6 is a diagram illustrating a process in which the radio control device according to one embodiment of the present disclosure determines whether the Internet radio and the first analog radio are the same broadcast in two steps.

The radio control device 24 may calculate the similarity between the Internet radio and the first analog radio based on a certain time cycle. The radio control device 24 may sequentially store the calculated similarity in a matrix of a certain size. For example, the radio control device 24 may store five calculated similarities in time order in a matrix of size 1×5. When the number of calculated similarities is greater than the size of the matrix, the radio control device 24 may overwrite an old similarity with a newly calculated similarity. For example, when a new similarity is calculated as one time cycle passes, the radio control device 24 may delete the oldest similarity in the existing matrix and store a new similarity in that location.

Referring to FIG. 6, the radio control device 24 may determine whether the similarity calculated in the current period is equal to or greater than a threshold value (S610). The similarity may be calculated based on a process of calculating a DTAC value between the digital audio signal processed by the analog radio receiving and processing device 20 and the digital audio signal processed by an Internet radio receiving and processing device 22. When the similarity calculated in the current period is equal to or greater than the threshold value, the radio control device 24 may determine that the Internet radio and the first analog radio are the same broadcast and perform S550.

The radio control device 24 may determine whether, when the similarity calculated in the current cycle is less than the threshold value, three recently calculated similarities among the similarities calculated in the past cycles are all equal to or greater than the threshold value (S620). The radio control device 24 may determine whether, when sorted in chronological order among the similarities stored in the matrix, the three recently calculated similarities are all equal to or greater than the threshold value. The threshold value may be the same as the threshold value of S610. For example, the radio control device 24 may determine whether, among five similarities stored in a 1×5 matrix, three recently calculated similarities are all equal to or greater than the threshold value. The three recently calculated similarities may be values stored in adjacent positions in the matrix. In other words, the three recently calculated similarities may be similarities calculated in consecutive time cycles. When all three recently calculated similarities are equal to or greater than the threshold value, the radio control device 24 may determine that the Internet radio and the first analog radio are the same broadcast, and perform S550. When the similarity calculated in the current cycle is determined to be less than the threshold value in S610, i.e., the Internet radio and the first analog radio are determined to be different broadcasts, but when three recently calculated similarities among the similarities calculated in the past cycle are determined to be equal to or greater than the threshold value in S620, the determination that the Internet radio and the first analog radio are different broadcasts may be corrected to determine that they are the same broadcast. This is because when the vehicle enters an underpass or the like and the signal quality of the first analog radio is determined to be not good, the similarity between the Internet radio and the first analog radio calculated based on the first analog radio received in the current cycle may be calculated to be lower than the actual value, and therefore, it may not be accurate to determine whether the Internet radio and the first analog radio are the same broadcast based on the similarity calculated in the current cycle. To solve this, the radio control device 24 of the present disclosure may determine that the Internet radio and the first analog radio are the same broadcast when all three recent similarities of the past cycles are equal to or greater than the threshold value in S620, even when the similarity of the current cycle is determined to be less than the threshold value in S610.

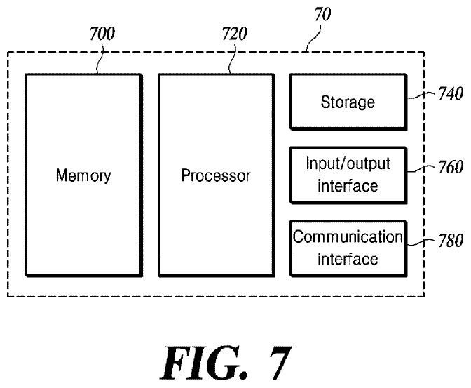

FIG. 7 is a block diagram schematically illustrating an example computing device according to one embodiment of the present disclosure that can be used to implement apparatuses and methods described in the present disclosure.

The computing device 70 may include all or part of a memory 700, a processor 720, a storage 740, an input/output interface 760, and a communication interface 780. The computing device 70 may be a stationary computing device, such as a desktop computer or a server, or a mobile computing device, such as a laptop computer or a smart phone. The computing device 70 may include a specialized hardware accelerator capable of processing operations of an artificial intelligence model in an efficient manner. For example, the computing device 70 may include a graphic processing unit (GPU), a tensor processing unit (TPU), or a neural processing unit (NPU).

The memory 700 may store a program that enables the processor 720 to perform methods or operations according to various embodiments of the present disclosure. For example, a program may include a plurality of instructions executable by the processor 720, and the methods or operations described above may be performed by executing the plurality of instructions by the processor 720. The memory 700 may consist of a single memory or a plurality of memories. In this case, information required to perform the methods or operation according to various embodiments of the present disclosure may be stored in a single memory or distributed across a plurality of memories. When the memory 700 is composed of a plurality of memories, the plurality of memories may be physically separated. The memory 700 may include at least one of volatile memory and non-volatile memory. Volatile memory includes Static Random Access Memory (SRAM) or Dynamic Random Access Memory (DRAM), while non-volatile memory includes flash memory.

The processor 720 may include at least one core capable of executing at least one instruction. The processor 720 may execute instructions stored in the memory 700. The processor 720 may consist of a single processor or a plurality of processors.

The storage 740 maintains stored data even if power supplied to the computing device 70 is cut off. For example, the storage 740 may include non-volatile memory or may include a storage medium such as a magnetic tape, an optical disk, or a magnetic disk. A program stored in the storage 740 may be loaded into the memory 700 before being executed by the processor 720. The storage 740 may store files written in a program language, and a program created from the files by a compiler may be loaded into the memory 700. The storage 740 may store data to be processed by the processor 720 and/or data processed by the processor 720.

The input/output interface 760 may provide an interface with an input device such as a keyboard or a mouse and/or an output device such as a display device or a printer. The user may trigger execution of a program by the processor 720 through the input device and/or check the processing results of the processor 720 through the output device.

The communication interface 780 may provide access to an external network. The computing device 70 may communicate with other devices through the communication interface 780.

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an example description of the technical idea of one embodiment of the present disclosure. In other words, those having ordinary skill in the art to which one embodiment of the present disclosure belongs may appreciate that various modifications and changes can be made without departing from essential features of an embodiment of the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art will appreciate that various modifications, additions, and substitutions are possible, without departing from the idea and scope of the claimed inventive concept. Therefore, embodiments of the present disclosure have been described for the sake of brevity and clarity. The scope of the technical idea of the present embodiments is not limited by the illustrations. Accordingly, one of ordinary skill in the art would understand that the scope of the claimed inventive concept is not to be limited by the above explicitly described embodiments but by the claims and equivalents thereof.

What is claimed is:

1. A control method of a vehicle radio apparatus, the control method comprising:
confirming a broadcast name of an Internet radio being listened to;
searching a frequency at which a first analog radio having the broadcast name is being transmitted;
determining whether a signal quality of the first analog radio received at the frequency is good;
determining whether the Internet radio and the first analog radio are the same broadcast when it is determined that the signal quality of the first analog radio is not good; and
converting the Internet radio into a second analog radio and transmitting the second analog radio when it is determined that the Internet radio and the first analog radio are the same broadcast.

2. The method of claim 1, wherein the determining of whether the Internet radio and the first analog radio are the same broadcast includes calculating a similarity based on a correlation coefficient between the Internet radio and the first analog radio.

3. The method of claim 2, wherein the determining of whether the Internet radio and the first analog radio are the same broadcast further includes determining whether the similarity exceeds a threshold value.

4. The method of claim 3, wherein the determining of whether the Internet radio and the first analog radio are the same broadcast further includes determining whether, for one or more similarities between the Internet radio and the first analog radio calculated in advance at a certain time cycle, each of the similarities exceeds the threshold value.

5. A vehicle radio apparatus, comprising:
an Internet radio receiving and processing device;
an analog radio receiving and processing device;
a radio control device; and
an analog radio transmitting and processing device,
wherein the radio control device is configured to:
confirm a broadcast name of an Internet radio being listened to, using the Internet radio receiving and processing device;
search a frequency at which a first analog radio having the broadcast name is being transmitted, using the analog radio receiving and processing device;
determine whether a signal quality of the first analog radio received at the frequency is good;
determine whether the Internet radio and the first analog radio are the same broadcast when it is determined that the signal quality of the first analog radio is not good; and
convert the Internet radio into a second analog radio and transmit the second analog radio, using the analog radio transmitting and processing device when it is determined that the Internet radio and the first analog radio are the same broadcast.

6. The vehicle radio apparatus of claim 5, wherein the radio control device determines whether the Internet radio and the first analog radio are the same broadcast by calculating a similarity based on a correlation coefficient between the Internet radio and the first analog radio.

7. The vehicle radio apparatus of claim 6, wherein the radio control device determines whether the Internet radio and the first analog radio are the same broadcast by determining whether the similarity exceeds a threshold value.

8. The vehicle radio apparatus of claim 7, wherein the radio control device determines whether the Internet radio and the first analog radio are the same broadcast by determining whether, for one or more similarities between the Internet radio and the first analog radio calculated in advance at a certain time cycle, each of the similarities exceeds the threshold value.

9. A vehicle radio apparatus comprising an analog radio receiving and processing device that receives a second analog radio transmitted by a surrounding vehicle,
wherein the second analog radio is a signal generated by the surrounding vehicle based on:
confirming a broadcast name of an Internet radio being listened to;
searching a frequency at which a first analog radio having the broadcast name is being transmitted;
determining whether a signal quality of the first analog radio received at the frequency is good;
determining whether the Internet radio and the first analog radio are the same broadcast when it is determined that the signal quality of the first analog radio is not good; and
converting the Internet radio into the second analog radio when it is determined that the Internet radio and the first analog radio are the same broadcast.

10. The vehicle radio apparatus of claim 9, wherein the determining of whether the Internet radio and the first analog radio are the same broadcast includes calculating a similarity based on a correlation coefficient between the Internet radio and the first analog radio.

11. The vehicle radio apparatus of claim 10, wherein the determining of whether the Internet radio and the first analog radio are the same broadcast further includes determining whether the similarity exceeds a threshold value.

12. The vehicle radio apparatus of claim 11, wherein the determining of whether the Internet radio and the first analog radio are the same broadcast further includes determining whether, for one or more similarities between the Internet radio and the first analog radio calculated in advance at a certain time cycle, each of the similarities exceeds the threshold value.
